(19) United States
(12) Patent Application Publication
(10) Pub. No.: US 2013/0007091 A1
(43) Pub. Date: Jan. 3, 2013

(54) METHODS AND APPARATUSES FOR STORING SHARED DATA FILES IN DISTRIBUTED FILE SYSTEMS

(75) Inventors: Sriram Rao, San Jose, CA (US); Adam Silberstein, Sunnyvale, CA (US); Russell Sears, Berkeley, CA (US); Azza Abouzeid, New Haven, CT (US)

(73) Assignee: Yahoo! Inc., Sunnyvale, CA (US)

(21) Appl. No.: 13/175,782

(22) Filed: Jul. 1, 2011

(51) Int. Cl. G06F 15/16

(52) U.S. Cl. 709/201

(57) ABSTRACT

Various methods and apparatuses are provided which may be implemented using one or more computing devices within a networked computing environment to support a computing grid having selective storage of shared data files within certain distributed the systems provided by dusters of computing devices. The selective storage may represent limited duplicative storage of a shared file.

### BACKGROUND

1. Field

The subject matter disclosed herein relates to data processing and storage.

2. Information

Data processing tools and techniques continue to improve. With such tools and techniques, various information encoded or otherwise represented in some manner by one or more electrical signals may be identified, collected, shared, shared, analyzed, etc. Databases and other like data repositories are common place, as are related communication networks and computing resources that provide access to such information.

Recently there has been a move within the information technology (IT) industry to establish sufficient communication and computing device infrastructures to provide for all or part of the data processing or data storage for one or more user entities. Such arrangements may, for example, comprise an aggregate capacity of computing resources, which may sometimes be referred to as providing a “cloud” computing service or capability. So-called “cloud” computing likely derives its name because, at least from a system-level perspective of a user entity (e.g., a person, or business, an organization, etc.), at least some to the data processing or data storage capability provided to a user entity by one or more service providers may be viewed as being within a “cloud” that often represents one or more communication networks, such as an intranet, the Internet, or the like, or combination thereof. Hence, many user entities may contract with a service provider for such cloud computing or other like data processing or data storage services. In certain instances, a user entity, such as, for example, a large corporation or government organization, may act as its own service provider by providing and administering its own cloud computing service. Thus, a service provider may provide such data processing or data storage capabilities to one or more user entities or itself.

While the details of the underlying infrastructure that provides a cloud computing capability may remain unknown to a user entity, a service provider will likely be aware of the technologies and devices arranged to provide such capabilities. When designing their infrastructure, a service provider may seek to provide certain levels of performance and security with regard to data processing, data storage, or other aspects regarding the handling or communication of data relating to a user entity. For many user entities, cloud computing services may be particularly beneficial in that such cloud computing may provide enhanced levels of data processing performance or possibly more reliable data storage, than the user entity might otherwise provide through their own devices. Indeed, in certain instances a user entity may forego purchasing certain devices and rely instead on a cloud computing service.

As more and more user entities turn to service providers for various on-line data processing or data storage services, such as cloud computing services, service providers will continue to strive to make efficient use of their communication and computing infrastructure. As such, there is continuing need for methods and apparatuses that may provide for more efficient use of their communication and computing devices.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an example implementation of a networked computing environment comprising a computing grid for selectively storing shared data files within certain distributed file systems, in accordance with certain example implementations.

FIG. 2 is a schematic block diagram illustrating certain features of an example computing device that may be used in a computing grid to support the selective storage of shared data files within certain distributed file systems, in accordance with certain example implementations.

FIG. 3 is a flow diagram illustrating a process implementable in one or more computing devices in a computing grid to support selective storage of shared data files within certain distributed file systems, in accordance with certain example implementations.

### DETAILED DESCRIPTION

Various example methods and apparatuses are provided herein which may be implemented using one or more computing devices within a networked computing environment. Methods and apparatuses may, for example, support a computing grid having a capability to selective store shared data files within certain distributed file systems, which may be provided by clusters of computing devices. Selective storage may represent limited duplicative storage of a shared file. Consequently, for example, more efficient use of certain computing resources, such as data storage devices (memory) may be provided.

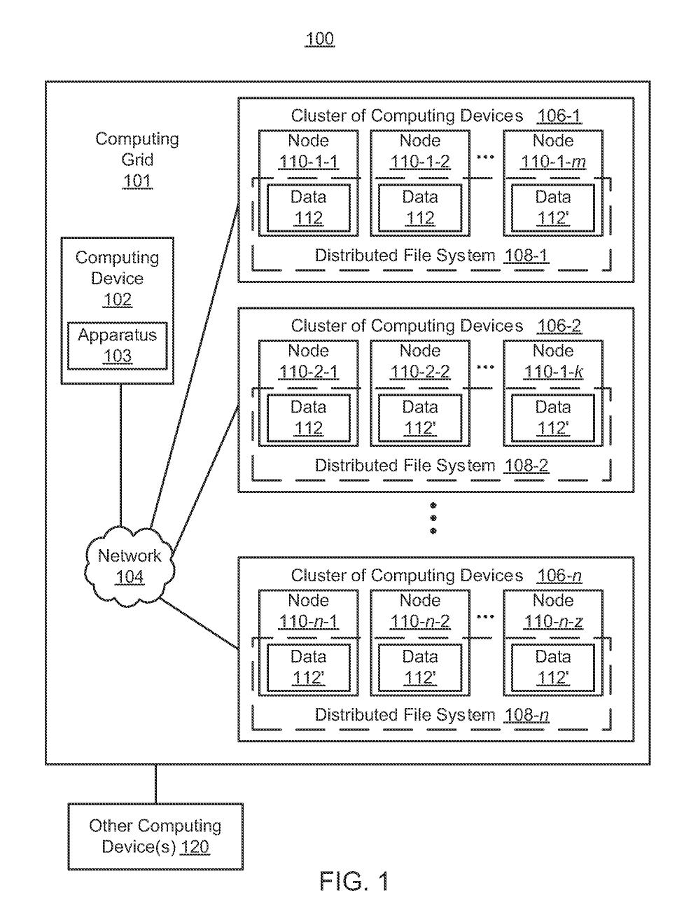

By way of example, FIG. 1 illustrates an example implementation of a networked computing environment 100 comprising a computing grid 101 for selectively storing shared data files (e.g., represented via data signals 112 and possibly data signals 112′) within certain distributed file systems 108. In certain example implementations, computing grid 101 may provide data processing or data storage capabilities to one or more other computing devices 120. By way of a non-limiting example, in certain instances computing grid 101 may be enabled to provide so-called “cloud” computing or other like data processing or data storage capabilities or services to a user entity associated with one or more other computing devices 120. It should be recognized that in certain other example implementations, a plurality of computing grids may be provided, which may be of the same or similar design or of different designs.

Example computing grid 101 comprises a plurality of distributed file systems 108, which may be provided using a plurality of clusters of computing devices, e.g., represented by clusters 106 and computing nodes 110, respectively. As described in greater detail below, all or part of a shared data file may be selectively stored using a limited number (one or more) of the computing nodes 110 in one or more of the clusters, for example, to reduce usage of memory resources. Further, example techniques are provided which may be implemented to allow all or part of a shared data file to be provided to one or more other clusters/distributed file systems.

For example, distributed file system 108-1 is shown as being provided by cluster 106-1, which comprises computing nodes 110-1-1, 110-1-2, through 110-1-m, where in is an integer value. As shown, data signals 112 and possibly 112′ may represent all or part of a shared data file. In FIG. 1, a data signal 112′ is intended to represent, as a placeholder, that in certain instances all or part of a shared data file may or may not be stored at a particular node 110. This, in certain example instances, a shared data file may be stored using one or more data signals 112, while in certain other instances, a shared data file may be stored using one or more data signals 112 and one or more further data signals 112′. Data signals 112/112′ may, for example, be processed in some manner using one or more processing units (not shown) at one or more of computing nodes 110-1-1, 110-1-2, through 110-1-m. Data signals 112/112′ may, for example, be stored in some manner using memory (not shown) at one or more of computing nodes 110-1-1, 110-1-2, through 110-1-m.

Similarly, for example, distributed file system 108-2 is shown as being provided by cluster 106-2, which comprises computing nodes 110-2-1, 110-2-2, through 110-2-k, where k is an integer value. Data signals 112/112′ may, for example, be processed in some manner using one or more processing units (not shown) at one or more of computing nodes 110-2-1, 110-2-2, through 110-2-k. Data signals 112/112′ may, for example, be stored in some manner using memory (not shown) at one or more of computing nodes 110-2-1, 110-2-2, through 110-2-k.

Additional distributed file systems 108 may also be provided, for example, as represented by distributed file system 108-n in cluster 106-n, which comprises computing nodes 110-n-1, 110-n-2, through 110-n-z, where z is an integer value. Data signals 112′ (when present) may, for example, be processed in some manner using one or more processing units (not shown) at one or more of computing nodes 110-n-1, 110-n-2, through 110-n-z. Data signals 112′ (when present) may, for example, be stored in some manner using memory (not shown) at one or more of computing nodes 110-n-1, 110-n-2, through 110-n-z. As illustrated by only showing data signals 112′ in distributed file system 108-n, at times there may be no shared file data present in distributed file system 108-n. As pointed out in greater detail in subsequent sections, in certain instances a cluster that does not have a particular shared data file may nonetheless obtain all or part of such shared data file from another cluster via network 104, e.g., with the assistance of computing device 102 in response to a request or need for such shared data file.

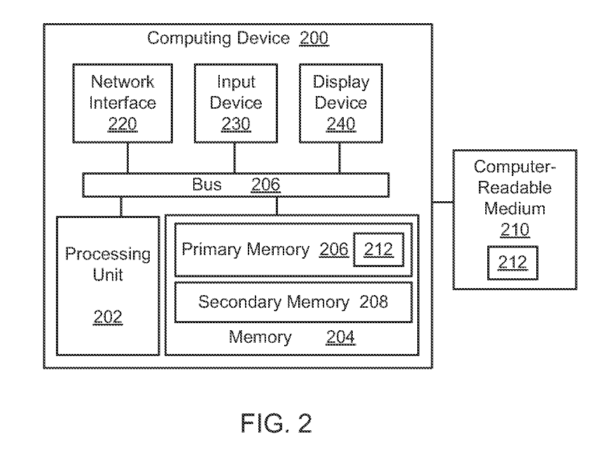

In certain example implementations, a computing node may comprise a local memory (e.g., as illustrated in FIG. 2). In certain example implementations, memory (not shown) may comprise a storage area network that may be accessible by a plurality of the computing nodes. In certain example implementations, one or more computing nodes may be part of a storage appliance, such as a file server or the like, and computing device 102 may be part of commodity appliance employed to coordinate storage of data signals 112/112″, e.g., with apparatus 103 determining which storage appliances should store copies of shared data files.

By way of non-limiting example, in certain enterprise level implementations, values for variables m, k, or z (which may be the same or different) may be greater than one thousand, and a value of variable n may be greater than ten. Hence, a computing grid 101 may represent a significantly large computing environment in certain instances; however, claimed subject matter is not limited in this manner.

As illustrated in an example in FIG. 1, dusters 106-1 through 106-n may be operatively coupled together via one or more networks or other like data signal communication technologies, which are represented here as network 104. Thus, for example, network 104 may comprise one or more wired or wireless telecommunication systems or networks, one or more local area networks or the like, an intranet, the Internet, etc.

Example computing grid 101 is also illustrated as comprising a computing device 102. Computing device 102 is representative of one or more computing devices, each of which may comprise one or more processing units (not shown), Computing device 102 may be operatively coupled to clusters 106-1 through 106-n, for example, through network 104. As illustrated, computing device 102 may comprise an apparatus 103, which as described in greater detail herein may be employed to initiate, coordinate, or otherwise control selective storage of certain data signals in a portion of distributed file systems 108-1 through 108-n.

For example, apparatus 103 may determine whether a data file associated with computing grid 101 is a “shared data file” with regard to distributed data file systems 108-1 through 108-n based on various criteria. In certain instances it may be beneficial to limit storage of certain shared files within a computing grid 101, for example, to reduce an amount of data storage (memory) space used. In certain instances it may be beneficial to limit storage of certain shared files within a computing grid 101, for example, due to certain contractual or legal obligations, or security policies or the like.

In certain example implementations, for example, should a data file be determined to be a shared data file and should a number of distributed the systems 108 satisfy a first threshold number, apparatus 103 may initiate transmission of one or more electrical signals (e.g., over network 104) to initiate limited storage of the shared data file in only a portion of a distributed data file systems 108. For example, certain shared data files may be stored in only a single distributed file system 108-1 as opposed to all of the distributed file systems 108-1 through 108-n. In other example implementations, certain shared data files may be stored in two or more, but not all of distributed data file systems 108-1 through 108-n, e.g., to provide for redundancy, improved processing efficiency, or based on other like considerations.

In certain example implementations, apparatus 103 may determine that a shared data file which was stored in a distributed data file system 108 may have become unavailable for some reason. For example, a stored data file may become unavailable in a distributed data file system while the distributed data file system is offline, or experiencing technical problems, etc. In certain example implementations, apparatus 103 may determine that a shared data file has become unavailable from a distributed data file system 108 based on information or lack thereof from distributed data file system 108 or associated cluster 106. For example, apparatus 103 may actively contact or scan clusters 106, or some master control computing device therein (not shown), for applicable status information, or clusters 106 (or some master control computing device therein) may actively contact apparatus 103 to provide applicable status information which may be used to determine whether a shared data file may be available or unavailable.

In certain example implementations, apparatus 103 may initiate or otherwise request one or more specific data processing tasks from a specific cluster 106, wherein to complete a task at least one shared data file would need to be available in distributed file system 108 provided by specific cluster 106. Thus, should a task be successfully performed by specific cluster 106 then apparatus 103 may determine that one or more shared files are available as stored within corresponding distributed file system 108. However, should a specific cluster be unable to perform a task because one or more shared data files (or a portion of) are unavailable, then apparatus 103 may determine that a shared data file or portion thereof is unavailable within corresponding distributed file system 108.

In response to determining that a shared data file that was stored in a distributed file system is unavailable for some reason, apparatus 103 may, for example, initiate storage of a duplicate copy of a shared data file in another distributed file system.

In certain example implementations, apparatus 103 may determine that a shared data file may be needed by a particular cluster 106 (e.g., to perform a task) but may be unavailable in corresponding distributed file system 108. Thus, apparatus 103 may, for example, initiate storage of all or part of a shared data e in particular distributed file system 108.

There are a variety of ways in which a data file may be identified and copied or moved from one or more computing devices to one or more other computing devices over a network. By way of a non-limiting example, hi certain implementations apparatus 103 may access a shared file in a first distributed file system via one or more computing devices in a first cluster and provide a copy of a shared data file to one or more computing devices in a second duster for storage in a second distributed file system. In another non-limiting example, in certain implementations apparatus 103 may indicate to one or more computing devices in a second duster providing a second distributed file system that a shared file may be accessed or otherwise obtained from a first distributed file system via one or more computing devices in a first cluster. Thus, one or more computing devices in a second duster may subsequently communicate with one or more computing devices in a first cluster to obtain a shared data file. However, it should be kept in mind that claimed subject matter is not intended to be limited to these examples. Through these or other know techniques, a shared data file may be duplicated (e.g., copied and stored), or moved (e.g., copied and erased, and then stored elsewhere), or otherwise maintained in a limited number and manner in a portion of distributed file systems 108.

In certain example implementations, apparatus 103 may, for example, determine that at least a portion of a shared data file that was stored in a distributed data file system has become unavailable. Here, for example, should an applicable number of computing nodes 110 providing a distributed file system 108 fail for some reason it may be that at least a portion of a shared data file may be lost or unrecoverable within a distributed file system. Thus, apparatus 103 may, for example, initiate restoration of storage of a shared data file, e.g., for example, by providing a copy of all or part of a shared data file or information identifying another cluster and corresponding distributed data file system from which all or part of a shared data file by be obtained.

In certain example implementations, apparatus 103 may consider a number of distributed file systems 108 which are available to store a copy of a shared file. As mentioned, for example, apparatus 103 may limit storage of a shared file to a certain number of distributed file systems provided there are at least a first threshold number of distributed file systems. In certain example implementations, a first threshold number may be two, which may allow for limited storage of a shared file in one of two distributed file systems. In certain other example implementations, a first threshold number may be three or more which may allow for limited storage of a shared file in one or two, or possibly three or more distributed file systems, but not all distributed file systems.

In certain other example implementations, apparatus 103 may also consider a second threshold number to limit storage of a shared data file to a specific number or possibly a specific range of numbers based, at least in part, on a second threshold number. For example, a second threshold number may indicate that apparatus 103 should operatively maintain copies of a shared data file in a certain number of distributed file systems. In another example, a second threshold number may indicate that apparatus 103 should operatively maintain copies of a shared data file in at least a minimum number of distributed file systems or should attempt to maintain copies of a shared data file in a number of distributed file systems within a range of a second threshold number.

For example, a second threshold number may be one and apparatus 103 may limit storage of a shared data file to storage in one distributed data file system 108, assuming that there are two or more distributed data file systems. In another example, a second threshold number may be two or greater but less than a first threshold number, and apparatus 103 may limit storage of a shared data file to storage in two or more, but a not all distributed data file systems.

By way of further example, assume that there are three distributed file systems (e.g., in FIG. 1, n=3) and a first threshold number is set to four. In this situation, apparatus 103 would not be able to limit storage of a shared data file since there are fewer than a first threshold number of distributed file systems.

However, assume next that there are ten distributed file systems (e.g., in FIG. 1, n=10) and a first threshold number is set to four. In this situation, apparatus 103 would be able to limit storage of a shared data file since there are more than a first threshold number of distributed file systems. Thus,rather than have a shared data file stored on each of ten distributed file systems (e.g., 108-1 through 108-10), apparatus 103 may, for example, limit storage of a shared data file to nine or fewer of ten distributed file systems. Assume further that, a second threshold number is set to three. As such, apparatus 103 may, for example, limit or attempt to limit duplicative storage of a shared data file to three of ten distributed data file systems, or otherwise attempt to maintain duplicative storage of a shared data file on at least three of ten distributed data file systems, but not all ten. Accordingly, in certain example implementations, apparatus 103 may either initiate removal of a shared data file from one or more of distributed data file systems 108, or initiate storage of a shared data file in one or more of distributed data file systems 108, e.g., in an effort to adhere to or maintain duplicated storage levels based on a second threshold number.

In certain example implementations, a first threshold value may be based, at least in part, on a design or an operative attribute associated with all or part of computing grid 101. For example, it may be less or more beneficial to limit duplicative storage of a shared data signals in a computing grid 101 depending on a number, location, type, or other like operative attributes or performance considerations of various clusters 106, distributed file systems 108, computing nodes 110, network 104, or data processing or data storage services to be provided.

In certain example implementations, a second threshold value may also be based, at least in part, on a same or similar design or operative attributes associated with all or part of computing grid 101. Additionally, a second threshold number may, for example, indicate a global minimum number of duplicate copies of a shared data file to store in computing grid 101.

In certain example implementations, a second threshold number may be based, at least in part, on at least one file attribute associated with a shared data file. By way of example, at least one file attribute may be considered in determining whether it may be less or more beneficial to limit duplicative storage of a shared data in a computing grid 101. For example, one or more file attributes may correspond to, other otherwise depend on: a type of information represented in a shared data file (e.g., how often information is needed, a categorization scheme, a priority scheme, a desired robustness level, a source of information, a likely destination of information, etc.); an age of information represented in a shared data file (e.g., based on a timestamp, lifetime, etc.); a size of a shared data file (e.g., larger data files may be more limited than relatively smaller files, or visa versa, etc.); a processing requirement associated with information (e.g., certain data signal processing capabilities required, etc.); or the like or combination thereof.

Moreover, in certain example implementations, apparatus 103 may consider similar or other like design or operative attribute associated with all or part of computing grid 101 or one or more file attributes associated with a shared data file, in determining whether a shared data file is to be stored on a particular distributed file system 108. By way of an example, a shared data file may be stored in a specific distributed the system 108 based, at least in part, on a type of information in a shared data the and a location of a corresponding cluster. Here, for example, a shared data the associated with search engine queries from users in a particular geographical region may be stored in a distributed file system 108 associated with supporting search engine or other like tasks for that particular geographical region. Indeed, although not necessary, in certain instances cluster 106 corresponding to such applicable distributed file system 108 may itself be physically located within or nearby such particular geographical region. However, claimed subject matter is not limited in such manner.

In certain example implementations, a first threshold number or a second threshold number may be predetermined, e.g., based on administrator input, previous usage, some design attribute, some data file attribute, etc. In other example implementations, a first threshold number or a second threshold number may be determined dynamically by apparatus 103, e.g., based on some performance attribute associated with operating all or part of a computing grid, some design attribute, some data file attribute, etc.

Although apparatus 103 is illustrated in FIG. 1 as being in computing device 102 and separate from clusters 106, it should be understood that in certain other example implementations, computing device 102 or apparatus 103 may be provided within a cluster of computing devices. Additionally, it should be understood that in certain example implementations, computing device 102 may represent a plurality of computing devices or apparatus 103 may comprise a plurality of apparatuses, which may provide redundancy or distribute processing in some manner. In certain example implementations, a selected computing device 102 or apparatus 103 may be associated with all (or a subset) of clusters 106 or distributed file systems 108.

It should be understood that, if data signal 112 representing a shared data file is stored in a distributed file system, such shared data the need not be stored using all of computing nodes associated with a distributed file system. Thus, for example, all or part of a shared data file may be stored at a single computing node or using a plurality of computing nodes of a distributed file system. Further,in certain example implementations, all or part of a shared data file may be redundantly stored using one or more computing nodes associated with a distributed file system (e.g., one or more computing nodes may comprise one or more data storage devices or other like memory which provide for some form of a Redundant Array of Independent Disks (RAID) or other like redundant/recoverable data storage capability).

Although claimed subject matter is not intended to be limited, in certain example implementations a cluster 106 may be operated using an Apache™ Hadoop™ software framework (which is a well-known, open source Java framework for processing and querying vast amounts of data signals on large clusters of commodity hardware and is available from Apache Software Foundation (ASF), which is a non-profit organization incorporated in the United States of America); and further that, a corresponding distributed file system 108 may represent a Hadoop™ Distributed File System (HDFS), or other like file system. Thus, with this in mind, in certain example implementations, apparatus 103 may be arranged as a proxy computing node in computing grid 101 which communicates with at least a controlling NameNode (not shown) or other like master controlling computing device(s) within each of clusters 106-1 through 106-n via network 104. In certain example implementations, a proxy computing node may act as if in a particular cluster 106 and request/obtain data files or portions thereof that may be available from one or more other clusters.

In certain example implementations, a shared data file may comprise one or more data signals that are generated or otherwise gathered, and which may be of use to one or more data signal processing functions. Hence, in certain instances, a shared data file may be a read-only data file. Some non-limiting examples of a shared data file include; a search entry log file gathered over time and associated with a search engine or other like capability; a web crawl file gathered using a web crawler or other like capability; a raw data file associated with an experiment; a historical record file; or the like, or any combination thereof.

As further illustrated in FIG. 1, computing grid 101 may be operatively coupled to one or more other computing devices 120. Here, for example, other computing devices 120 may represent one or more computing or communication capabilities. Hence, in certain example implementations, other computing devices 120 may represent one or more computing devices that may be associated with a user entity and one or more communication networks or the like, which may operatively couple such computing devices to computing grid 101. Thus, for example, a user entity may initiate a data signal processing task within at least a portion of computing grid 101, via a computing device 120.

In another example implementation, other computing devices 120 may represent one or more computing devices that may be associated with a service provider or other like information source. Here, for example, other computing devices 120 may provide at least a portion of data signal 112/112′, and possibly all or part of a shared data file therein. For example, other computing devices 120 may provide a search entry log file, a web crawl file, a raw data file, a historical record file, etc.

Reference is made next to FIG. 2, which shows an example computing device 200 that may take a form, at least in part, of computing device 102, a computing node 110, and/or other computing device(s) 120 as illustrated in FIG. 1.

Computing device 200 may, for example, include one or more processing units 202, memory 204 and at least one bus 206.

Processing unit 202 is representative of one or more circuits configurable to perform at least a portion of a data signal computing procedure or process. By way of example but not limitation, processing unit 202 may include one or more processors, controllers, microprocessors, microcontrollers, application specific integrated circuits, digital signal processors, programmable logic devices, field programmable gate arrays, and the like, or any combination thereof.

Memory 204 is representative of any data storage mechanism. Memory 204 may include, for example, a primary memory 206 or a secondary memory 208. Primary memory 206 may include, for example, a solid state memory such as a random access memory, read only memory, etc. While illustrated in this example as being separate from processing unit 202, it should be understood that all or part of primary memory 206 may be provided within or otherwise co-located/coupled with processing unit 202.

Secondary memory 208 may include, for example, a same or similar type of memory as primary memory or one or more data storage devices or systems, such as, for example, a disk drive, an optical disc drive, a tape drive, a solid state memory drive, etc. In certain implementations, secondary memory 208 may be operatively receptive of, or otherwise configurable to couple to, a computer-readable medium 210. Computer-readable medium 210 may include, for example, any non-transitory media that can carry or make accessible data, code or instructions 212 for use, at least in part, by processing unit 202 or other circuitry within computing device 200. Thus, in certain example implementations, instructions 212 may be executable to perform one or more functions of apparatus 103 (FIG. 1).

In certain example implementations, a computing device 200 may include, for example, a network interface 220 that provides for or otherwise supports an operative coupling of computing device 200 to at least one network or another computing device. Network interface 220 may, for example, be coupled to bus 106. By way of example but not limitation, network interface 220 may include a network interface device or card, a modem, a router, a switch, a transceiver, or the like.

In certain example implementations, a computing device 200 may include at least one input device 230. Input device 230 is representative of one or more mechanisms or features that may be configurable to accept user input. Input device 230 may, for example, be coupled to bus 106. By way of example but not limitation, input device 230 may include a keyboard, a keypad, a mouse, a trackball, a touch screen, a microphone, etc., and applicable interface(s).

In certain example implementations, computing device 200 may include a display device 240. Display device 240 is representative of one or more mechanisms or features for presenting visual information to a user. Display device 240 may, for example, be coupled to bus 106. By way of example but not limitation, display device 240 may include a liquid crystal display (LCD) monitor, a cathode ray tube (CRT) monitor, a projector, or the like.

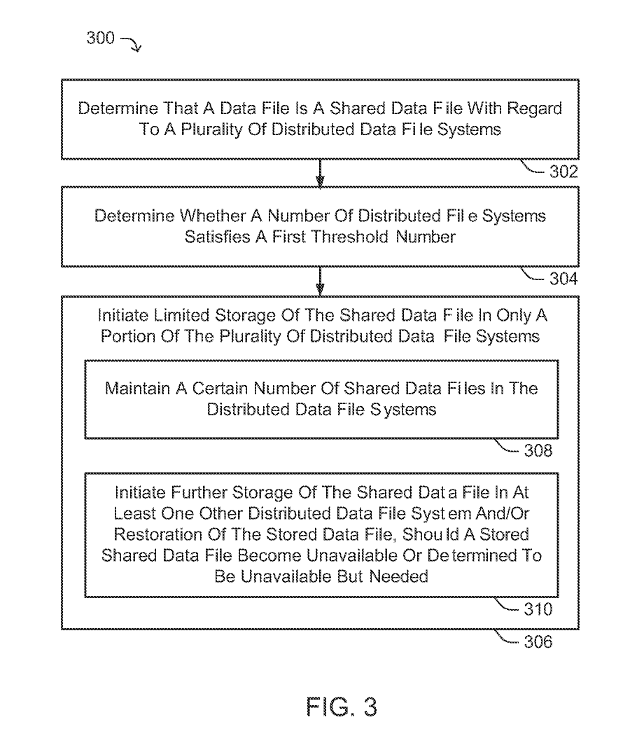

Reference is made next to FIG. 3, which is a flow diagram illustrating a process 300 implementable in computing grid 101, e.g., via apparatus 103 to support selective storage of shared data files within certain distributed file systems 108 (FIG. 1).

At block 302, at least one data file may be determined to be a shared data file with regard to a plurality of distributed data file systems 108. For example, certain log files, web-crawl files, historical record files, experimental data files, read-only data files, or the like or any combination thereof may be determined to be shared data file.

At block 304, it may be determined whether a number of distributed data systems 108 satisfies (e.g., meets or exceeds, or otherwise falls into some associated range of) a first threshold number.

At block 306, limited storage of a shared data file in only a portion of distributed data file systems 108 may be initiated. Here, for example, at block 308, a certain number of duplicate copies of a shared data file may be maintained in a portion of distributed data file systems 108. In another example, at block 310, further storage of a copy of a shared data file may be initiated in at least one other distributed file system if needed therein but unavailable, or if all or part of a shared data file is no longer available in another distributed the system.

Thus, as illustrated in various example implementations and techniques presented herein, in accordance with certain aspects a method may be provided for use as part of a special purpose computing device or other like machine that accesses digital signals from memory and processes such digital signals to establish transformed digital signals which may then be stored in memory.

Some portions of the detailed description have been presented in terms of processes or symbolic representations of operations on data signal bits or binary digital signals stored within memory, such as memory within a computing system or other like computing device. These process descriptions or representations are techniques used by those of ordinary skill in the data signal processing arts to convey the substance of their work to others skilled in the art. A process is here, and generally, considered to be a self-consistent sequence of operations or similar processing leading to a desired result. The operations or processing involve physical manipulations of physical quantities. Typically, although not necessarily, these quantities may take the form of electrical or magnetic signals capable of being stored, transferred, combined, compared or otherwise manipulated. It has proven convenient at times, principally for reasons of common usage, to refer to these signals as bits, data, values, elements, symbols, characters, terms, numbers, numerals or the like. It should be understood, however, that all of these and similar terms e to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “associating”, “identifying”, “determining”, “allocating”, “establishing”, “accessing”, “obtaining”, or the like refer to the actions or processes of a computing platform, such as a computer or a similar electronic computing device (including a special purpose computing device), that manipulates or transforms data represented as physical electronic or magnetic quantities within the computing platform's memories, registers, or other information (data) storage device(s), transmission device(s), or display device(s).

According to an implementation, one or more portions of an apparatus, such as computing device 200 (FIG. 2), for example, may store binary digital electronic signals representative of information expressed as a particular state of the device, here, computing device 200. For example, an electronic binary digital signal representative of information may be “stored” in a portion of memory 204 by affecting or changing the state of particular memory locations, for example, to represent info nation as binary digital electronic signals in the form of ones or zeros. As such, in a particular implementation of an apparatus, such a change of state of a portion of a memory within a device, such the state of particular memory locations, for example, to store a binary digital electronic signal representative of information constitutes a transformation of a physical thing, here, for example, memory device 204, to a different state or thing.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While certain exemplary techniques have been described and shown herein using various methods and apparatuses, it should be understood by those skilled in the art that various other modifications may be made, and equivalents may be substituted, without departing from claimed subject matter.

Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising, with at least one computing device:
determining that a data the is a shared data the with regard to a plurality of distributed data file systems within a computing grid, wherein each of said plurality of distributed file systems is provided via a corresponding cluster of computing nodes; and
in response to a determination that a number of said plurality of distributed file systems satisfies a first threshold number, initiating transmission of one or more electrical signals to initiate limited storage of said shared data file in only a portion of said plurality of distributed data file systems.

2. The method as recited in claim 1, further comprising, with said at least one computing device:
in response to a determination that said shared data file stored in one of said portion of said plurality of distributed data file systems is either unavailable or is needed in another one of said plurality of distributed data file systems, initiating transmission of one or more additional electrical signals to initiate further storage of said shared data file in said another one of said plurality of distributed data file systems.

3. The method as recited in claim 1, further comprising, with said at least one computing device:
in response to a determination that at least a portion of said shared data file stored in one of said portion of said plurality of distributed data file systems is unavailable, initiating transmission of one or more additional electrical signals to initiate restoration of said storage of at least said portion of said shared data file in said one of said portion of said plurality of distributed data file systems.

4. The method as recited in claim 1, :herein said portion of said plurality of distributed data file systems comprises at least a second threshold number of said plurality of distributed data file systems, said second threshold number being greater than two and less than said first threshold number.

5. The method as recited in claim 4, further comprising, with said at least one computing device:
maintaining said number of said portion of said plurality of distributed data file systems equal to said second threshold number by selectively initiating transmission of one or more additional electrical signals to either initiate removal of said shared data file, from one or more of said portion of said plurality of distributed data file systems or storage of said shared data the in one or more of said plurality of distributed data the systems.

6. The method as recited in claim 4, wherein said second threshold number is based, at least in part, on at least one of: at least one the attribute associated with said shared data file, or at least one system attribute associated with at least one of said plurality of distributed data file systems.

7. The method as recited in claim 1, wherein at least a portion of said shared data the comprises a read-only data file.

8. The method as recited in claim 1, wherein at least a portion of said shared data file is redundantly stored in at least one of said portion of said plurality of distributed data file systems using two or more of said computing nodes in said corresponding duster of computing nodes.

9. An apparatus comprising:
a network interface; and
at least one processing unit to:
determine that a data file is a shared data file with regard to a plurality of distributed data file systems, each of said plurality of distributed file systems being provided via a corresponding duster of computing nodes;
determine a number of said plurality of distributed file systems; and
in response to a determination that said number of said plurality of distributed file systems satisfies a first threshold number, initiate transmission of one or more electrical signals via said network interface indicative that said shared data file is to be stored in only a portion of said plurality of distributed data file systems.

10. The apparatus as recited in claim 9, wherein said portion of said plurality of distributed data file systems comprises at least a second threshold number of said plurality of distributed data file systems, said second threshold number being greater than two and less than said first threshold number, and said at least one processing unit to further:
maintain said number of said portion of said plurality of distributed data file systems equal to said second threshold number by selectively initiating transmission of one or more additional electrical signals via said network interface indicative that either said shared data file be removed from one or more of said portion of said plurality of distributed data file systems; or that said shared data file be stored in one or more of said plurality of distributed data file systems.

11. The apparatus as recited in claim 10, wherein said second threshold number is based, at least in part, on at least one of: at least one file attribute associated with said shared data file, or at least one system attribute associated with at least one of said plurality of distributed data file systems.

12. The apparatus as recited in claim 9, said at least one processing unit to further:
in response to a determination that said shared data file stored in one of said portion of said plurality of distributed data file systems is either unavailable or is needed in another one of said plurality of distributed data file systems, initiate transmission of one or more additional electrical signals via said network interface indicative that said shared data file be stored in said another one of said plurality of distributed data file systems.

13. The apparatus as recited in claim 9, said at least one processing unit to further:
in response to a determination that at least a portion of said shared data file stored in one of said portion of said plurality of distributed data file systems is unavailable, initiate transmission of one or more additional electrical signals via said network interface indicative that at least said portion of said shared data file be restored in said one of said portion of said plurality of distributed data file systems.

14. The apparatus as recited in claim 9, wherein at least a portion of said shared data file comprises a read-only data file.

15. The apparatus as recited in claim 9, wherein said at least one processing unit is provided at a proxy computing node of a computing grid comprising said plurality of distributed file systems.

16. An article comprising;
a non-tangible computer-readable medium having stored therein computer-implementable instructions executable by at least one processing unit to:
determine that a data file is a shared data file with regard to a plurality of distributed data file systems, each of said plurality of distributed file systems being provided via a corresponding cluster of computing nodes;
determine a number of said plurality of distributed file systems; and
in response to a determination that said number of said plurality of distributed file systems satisfies a first threshold number, initiate transmission of one or more electrical signals via a network interface indicative that said shared data file is to be stored in only a portion of said plurality of distributed data file systems.

17. The article as recited in claim 16, wherein said portion of said plurality of distributed data the systems comprises at least a second threshold number of said plurality of distributed data the systems, said second threshold number being greater than two and less than said first threshold number, and said computer-implementable instructions being further executable by said at least one processing unit to:
maintain said number of said portion of said plurality of distributed data file systems equal to said second threshold number by selectively initiating transmission of one or more additional electrical signals via said network interface indicative that either said shared data file be removed from one or more of said portion of said plurality of distributed data file systems; or that said shared data file be stored in one or more of said plurality of distributed data file systems.

18. The article as recited in claim 16, said computer-implementable instructions being further executable by said at least one processing unit to:
in response to a determination that said shared data file stared in one of said portion of said plurality of distributed data file systems is either unavailable or is needed in another one of said plurality of distributed data file systems, initiate transmission of one or more additional electrical signals via said network interface indicative that said shared data file be stored in said another one of said plurality of distributed data file systems.

19. The article as recited in claim 16, said computer-implementable instructions being further executable by said at least one processing unit to:
in response to a determination that at least a portion of said shared data file stored in one of said portion of said plurality of distributed data file systems is unavailable, initiate transmission of one or more additional electrical signals via said network interface indicative that at least said portion of said shared data file be restored in said one of said portion of said plurality of distributed data file systems.

20. The article as recited in claim 16, wherein said at least one processing unit is provided at a proxy computing node of a computing grid comprising said plurality of distributed file systems.
